(19) United States
(12) Patent Application Publication
(10) Pub. No.: US 2025/0296223 A1
(43) Pub. Date: Sep. 25, 2025

(54) VERTICAL ARTICULATED ROBOT

(71) Applicant: SEIKO EPSON CORPORATION, Tokyo (JP)

(72) Inventors: Eiji INOMATA, MATSUMOTO-SHI (JP); Takuya OWA, MATSUMOTO-SHI (JP); Akio NIU, MATSUMOTO-SHI (JP); Naoki TSUKAHARA, MATSUMOTO-SHI (JP)

(21) Appl. No.: 19/084,510

(22) Filed: Mar. 19, 2025

(30) Foreign Application Priority Data
Mar. 21, 2024 (JP) 2024-044607

(51) Int. Cl. B25J 9/06; B25J 9/00; B25J 9/10; B25J 9/12; B25J 18/00

(52) U.S. Cl. CPC B25J 9/06; B25J 9/0009; B25J 9/102; B25J 9/104; B25J 9/126; B25J 18/00

(57) ABSTRACT

A vertical articulated robot includes a base, a first arm pivoting around a vertical axis with respect to the base, a second arm coupled to the first arm and pivoting around a first horizontal axis with respect to the first arm, a third arm coupled to the second arm and pivoting around a second horizontal axis with respect to the second arm, a first motor causing the second arm to pivot around the first horizontal axis with respect to the first arm, and a second motor causing the third arm to pivot around the second horizontal axis with respect to the second arm. The first motor and the second motor are respectively disposed in the first arm.

### CROSS-REFERENCE TO RELATED APPLICATIONS

The present application is based on, and claims priority from JP Application Serial Number 2024-044607, filed Mar. 21, 2024, the disclosure of which is hereby incorporated by reference herein in its entirety.

### BACKGROUND OF THE INVENTION

### 1. Technical Field

The present disclosure relates to a vertical articulated robot.

### 2. Related Art

A robot disclosed in JP-A-2019-063933 includes a robot main body including a base and a robot arm coupled to the base. The robot arm includes a first arm pivotally coupled to the base, a second arm pivotally coupled to the first arm, a third arm pivotally coupled to the second arm, a fourth arm pivotally coupled to the third arm, a fifth arm pivotally coupled to the fourth arm, and a sixth arm pivotally coupled to the fifth arm.

In addition, the robot disclosed in JP-A-2019-063933 includes a first motor causing the first arm to pivot with respect to the base, a second motor causing the second arm to pivot with respect to the first arm, a third motor causing the third arm to pivot with respect to the second arm, a fourth motor causing the fourth arm to pivot with respect to the third arm, a fifth motor causing the fifth arm to pivot with respect to the fourth arm, and a sixth motor causing the sixth arm to pivot with respect to the fifth arm.

However, in the robot disclosed in JP-A-2019-063933, the second motor and the third motor, which are heavy objects, are disposed at in a central portion of the second arm in a longitudinal direction. Therefore, it is difficult to reduce a weight of a tip of the robot arm, thereby causing a problem in that an inertial moment of the robot arm tends to increase.

### SUMMARY OF THE INVENTION

According to an aspect of the present disclosure, there is provided a vertical articulated robot including a base, a first arm pivoting around a vertical axis with respect to the base, a second arm coupled to the first arm and pivoting around a first horizontal axis with respect to the first arm, a third arm coupled to the second arm and pivoting around a second horizontal axis with respect to the second arm, a first motor causing the second arm to pivot around the first horizontal axis with respect to the first arm, and a second motor causing the third arm to pivot around the second horizontal axis with respect to the second arm. The first motor and the second motor are respectively disposed in the first arm.

### BRIEF DESCRIPTION OF DRAWINGS

FIG. 1 is a perspective view illustrating a vertical articulated robot according to a first embodiment.

FIG. 2 is a schematic view illustrating a joint of the vertical articulated robot illustrated in FIG. 1.

FIG. 3 is a cross-sectional view illustrating a first power transmission mechanism.

FIG. 4 is a cross-sectional view illustrating a second power transmission mechanism.

FIG. 5 is a cross-sectional view illustrating the second power transmission mechanism.

FIG. 6 is a side view illustrating a disposition of a first motor and a second motor.

FIG. 7 is a cross-sectional view illustrating a vertical articulated robot according to a second embodiment.

FIG. 8 is a side view illustrating a disposition of a first motor and a second motor.

FIG. 9 is a cross-sectional view illustrating a vertical articulated robot according to a third embodiment.

FIG. 10 is a cross-sectional view illustrating a vertical articulated robot according to a fourth embodiment.

### DETAILED DESCRIPTION OF THE INVENTION

Hereinafter, a vertical articulated robot according to the present disclosure will be described in detail based on embodiments illustrated in the accompanying drawings.

For convenience of description, in each drawing, three axes orthogonal to each other are illustrated as an X-axis, a Y-axis, and a Z-axis. In addition, hereinafter, for convenience of description, a direction parallel to the X-axis will be referred to as an “X-axis direction”, a direction parallel to the Y-axis will be referred to as a “Y-axis direction”, and a direction parallel to the Z-axis will be referred to as a “Z-axis direction”. In addition, an X-Y plane defined by the X-axis and the Y-axis is provided along a horizontal plane, and the Z-axis direction extends along a vertical direction. Therefore, hereinafter, a direction along the X-Y plane will be referred to as a horizontal direction. An arrow side of the Z-axis will be referred to as “up”, and a side opposite thereto will be referred to as “down”. In addition, in the present specification, “horizontal” includes not only a case of being completely horizontal, but also a case where the horizontal is inclined within ±5° with respect to the horizontal, for example, to such an extent that the inclination can be regarded as the horizontal from a technical common sense. Similarly, “vertical” includes not only a case of being completely vertical, but also a case where the vertical is inclined within ±5°, for example, to such an extent that the inclination can be regarded as the vertical from a technical common sense.

### First Embodiment

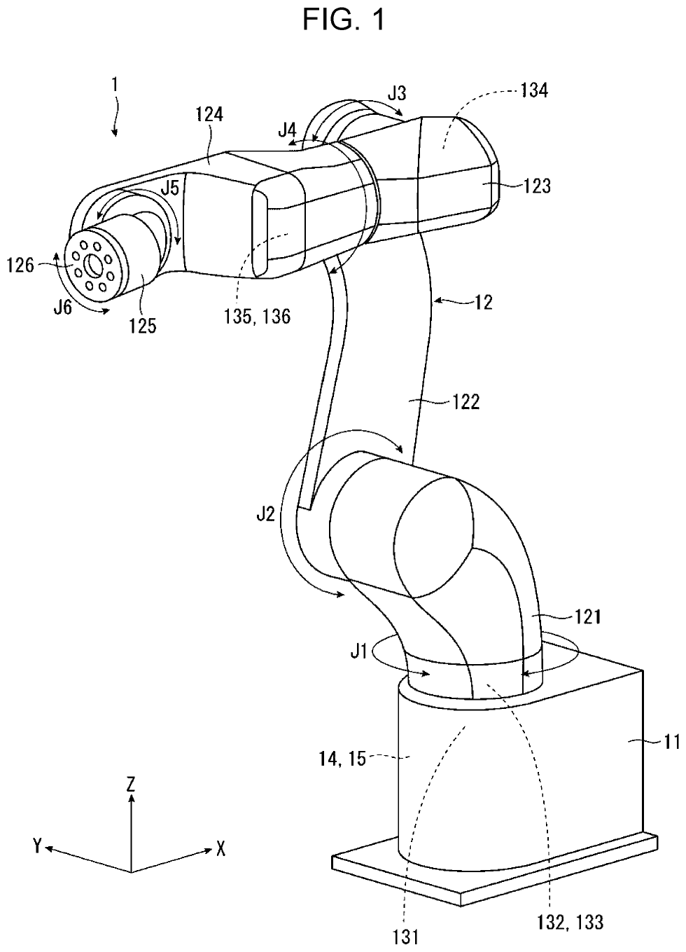

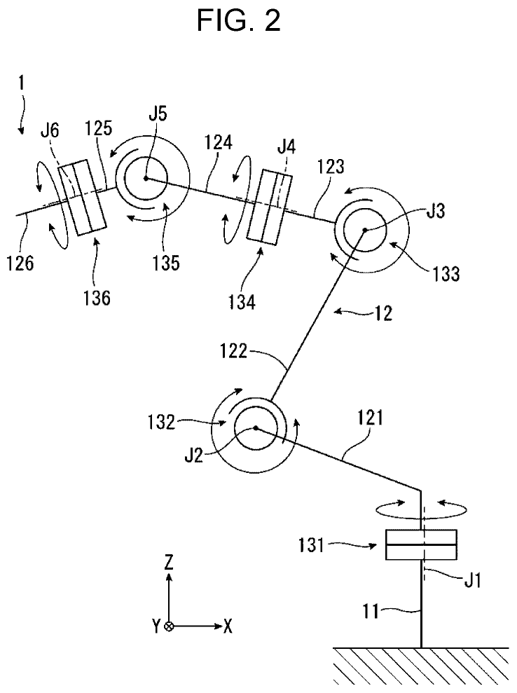

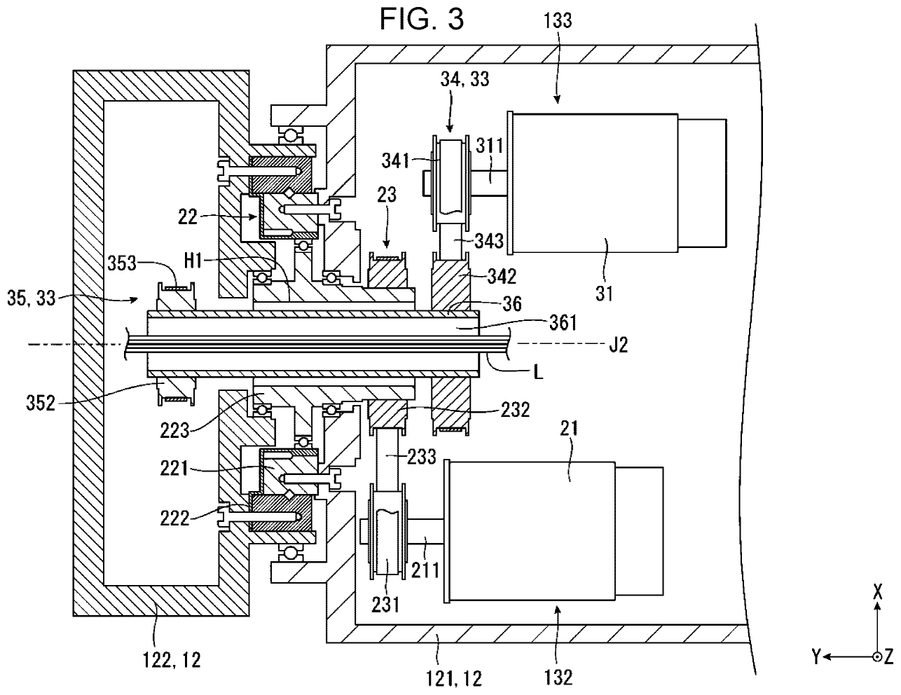

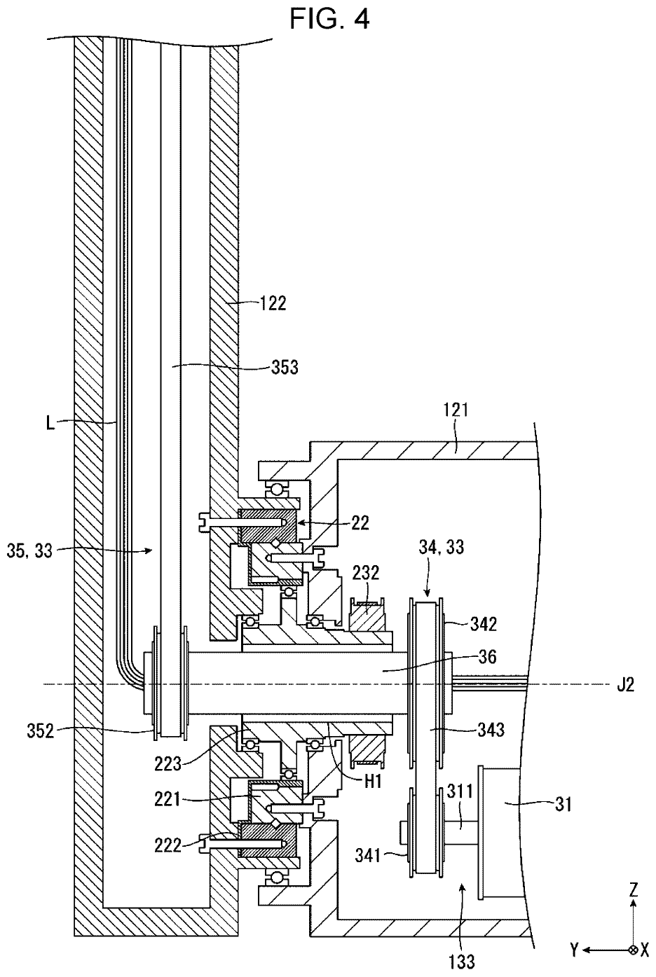

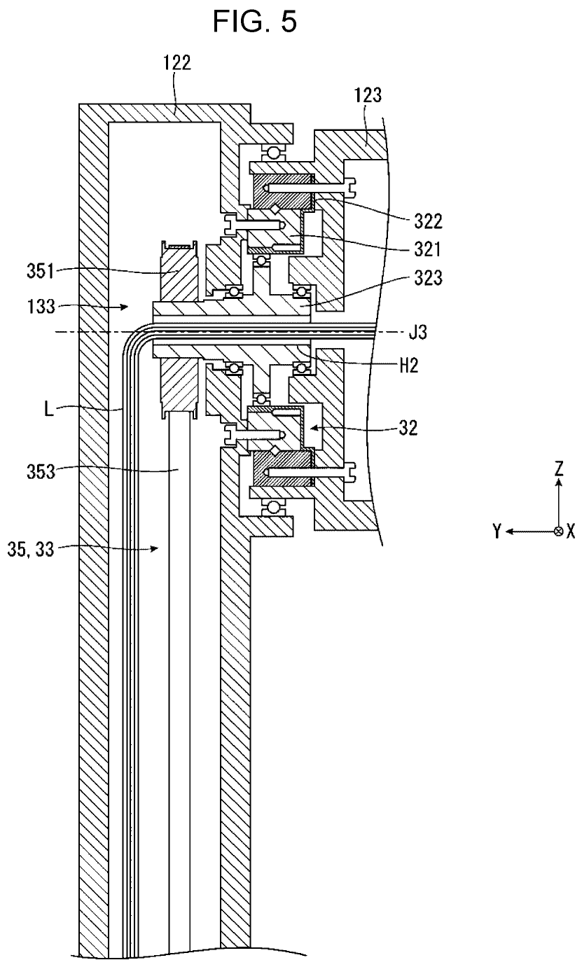

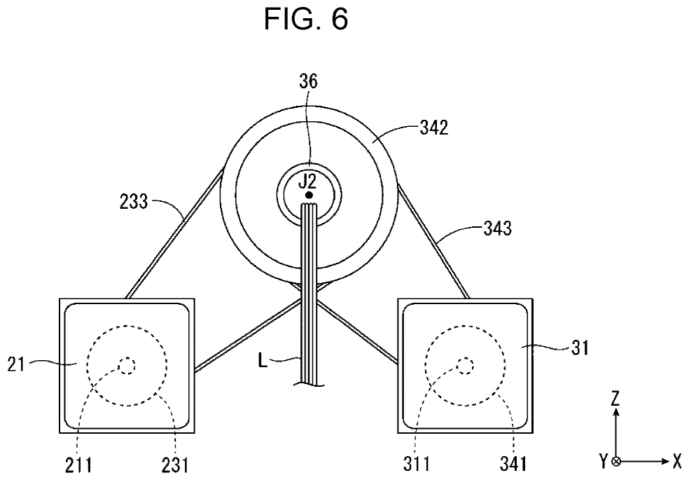

FIG. 1 is a perspective view illustrating a vertical articulated robot according to a first embodiment. FIG. 2 is a schematic view illustrating a joint of the vertical articulated robot illustrated in FIG. 1. FIG. 3 is a cross-sectional view illustrating a first power transmission mechanism. FIGS. 4 and 5 each are cross-sectional views illustrating a second power transmission mechanism. FIG. 6 is a side view illustrating a disposition of a first motor and a second motor.

A vertical articulated robot 1 illustrated in FIGS. 1 and 2 includes a base 11 and a robot arm 12 pivotally coupled to the base 11. For example, the base 11 is fixed to a floor. In addition, the robot arm 12 includes a first arm 121 pivotally coupled to the base 11 around a first pivoting axis J1 which is a vertical axis along a vertical direction, a second arm 122 pivotally coupled to the first arm 121 around a second pivoting axis J2 which is a first horizontal axis along a horizontal direction, a third arm 123 pivotally coupled to the second arm 122 around a third pivoting axis J3 which is a second horizontal axis along the horizontal direction, a fourth arm 124 pivotally coupled to the third arm 123 around a fourth pivoting axis J4, a fifth arm 125 pivotally coupled to the fourth arm 124 around a fifth pivoting axis J5 which is the horizontal axis along the horizontal direction, and a sixth arm 126 pivotally coupled to the fifth arm 125 around a sixth pivoting axis J6.

As illustrated in FIG. 1, the second arm 122 is coupled to the first arm 121 from one side in a direction along the second pivoting axis J2. In the illustrated example, the second arm 122 is coupled to the first arm 121 from a positive side in the Y-axis direction. That is, the second arm 122 is supported by the first arm 121 in a cantilevered manner in a base end portion. According to this configuration, a weight of the second arm 122 can be reduced. Therefore, the weight of the overall robot arm 12 can be reduced, and accordingly, an inertial moment of the robot arm 12 can be reduced. Therefore, the robot arm 12 can be more accurately controlled. The inertial moment may be referred to as inertia or inertial efficiency.

As illustrated in FIG. 1, the second arm 122 is supported by the third arm 123 from one side in the direction along the third pivoting axis J3. In the illustrated example, the second arm 122 supports the third arm 123 from a positive side in the Y-axis direction. That is, the second arm 122 supports the third arm 123 in a cantilevered manner in a tip portion thereof. According to this configuration, a weight of the second arm 122 can be reduced. Therefore, the weight of the overall robot arm 12 can be reduced, and accordingly, an inertial moment of the robot arm 12 can be reduced. Therefore, the robot arm 12 can be more accurately controlled.

As illustrated in FIGS. 1 and 2, the vertical articulated robot 1 includes a first drive unit 131 causing the first arm 121 to pivot around a first pivoting axis J1 with respect to the base 11, a second drive unit 132 causing the second arm 122 to pivot around a second pivoting axis J2 with respect to the first arm 121, a third drive unit 133 causing the third arm 123 to pivot around a third pivoting axis J3 with respect to the second arm 122, a fourth drive unit 134 causing the fourth arm 124 to pivot around a fourth pivoting axis J4 with respect to the third arm 123, a fifth drive unit 135 causing the fifth arm 125 to pivot around a fifth pivoting axis J5 with respect to the fourth arm 124, and a sixth drive unit 136 causing the sixth arm 126 to pivot around a sixth pivoting axis J6 with respect to the fifth arm 125. For example, each of the drive units 131 to 136 includes a motor which is a drive source, a speed reducer which decelerates rotation of the motor to increase and output a rotational force (torque), an encoder which detects a rotation amount of the motor, and the like.

As illustrated in FIG. 1, the vertical articulated robot 1 includes a control substrate 14 and a power supply substrate 15 which are disposed inside the base 11. However, a disposition of the control substrate 14 and the power supply substrate 15 is not particularly limited.

The control substrate 14 independently controls driving of the motor provided in each of the drive units 131 to 136. The control substrate 14 includes a substrate provided with a wire, and a central processing unit (CPU) which is an example of a processor, a random access memory (RAM), a read only memory (ROM) storing a program, and the like, which are provided in the substrate. A function of the CPU is achieved as a control section that controls driving of the vertical articulated robot 1 by reading and executing the program stored in the ROM.

The power supply substrate 15 supplies power to the control substrate 14. The power supply substrate 15 includes a substrate provided with a wire, and a conversion circuit provided in the substrate and converting power supplied from an outside into a predetermined value. The conversion circuit varies depending on a configuration of the vertical articulated robot 1. For example, examples of the conversion circuit include an AC/DC conversion circuit that converts an AC signal to a DC signal, a voltage raising circuit or a voltage lowering circuit that converts a voltage level of a signal, and the like.

Hitherto, an overall configuration of the vertical articulated robot 1 is briefly described. Next, the second drive unit 132 and the third drive unit 133, which are also features of the vertical articulated robot 1, will be described in detail. As described above, the second drive unit 132 is a unit causing the second arm 122 to pivot around the second pivoting axis J2 with respect to the first arm 121, and the third drive unit 133 is a unit causing the third arm 123 to pivot around the third pivoting axis J3 with respect to the second arm 122.

First, the second drive unit 132 will be described. As illustrated in FIG. 3, the second drive unit 132 includes a first motor 21 which is an encoder-incorporated motor, a first speed reducer 22 coupling the first arm 121 and the second arm 122, and a first power transmission mechanism 23 coupling the first motor 21 and the first speed reducer 22 and transmitting power of the first motor 21 to the first speed reducer 22.

The first motor 21 is disposed inside the first arm 121. In addition, an output shaft 211 of the first motor 21 is disposed along the second pivoting axis J2. In addition, the output shaft 211 of the first motor 21 is disposed at a position shifted from the second pivoting axis J2. In the present embodiment, in a plan view in the Z-axis direction, the first motor 21 is disposed at a position shifted to a negative side in the X-axis direction with respect to the second pivoting axis J2. As the first motor 21, a configuration is not particularly limited, but in the present embodiment, the first motor 21 is a servo motor, particularly, a three-phase motor driven by a three-phase AC. Since the first motor 21 is the servo motor, driving of the second arm 122 can be highly accurately and easily controlled.

The first speed reducer 22 is a wave gear device. Since the wave gear device is used as the first speed reducer 22, backlash of the first speed reducer 22 can be reduced. Therefore, the second arm 122 can be accurately controlled. However, as the first speed reducer 22, a configuration is not particularly limited, and a planetary gear device, a roller cam speed reducer, or the like may be used.

The first speed reducer 22 mainly includes a circular spline 221, a flex spline 222, and a wave generator 223. The circular spline 221 is fixed to the first arm 121, the flex spline 222 is fixed to the second arm 122, and the wave generator 223 is coupled to the first motor 21 via the first power transmission mechanism 23. In addition, the wave generator 223 has a tubular shape. Therefore, the first speed reducer 22 has a through-hole H1 communicating with the inside of the first arm 121 and the inside of the second arm 122 along the second pivoting axis J2. A wire L electrically couples at least one of the control substrate 14 and the power supply substrate 15 to each of the drive units of the robot arm 12. When an inertial sensor is provided in the robot arm 12, the wire L may include a wire that electrically couples at least one of the control substrate 14 and the power supply substrate 15 to the inertial sensor. As will be described later, the shaft 36 and the wire L are inserted into the through-hole H1.

The first power transmission mechanism 23 is disposed inside the first arm 121 together with the first motor 21. The first power transmission mechanism 23 includes a first motor-side pulley 231 attached to an output shaft 211 of the first motor 21, a first speed reducer-side pulley 232 attached to the wave generator 223 which is an input shaft of the first speed reducer 22, and a first belt 233 wound around the first motor-side pulley 231 and the first speed reducer-side pulley 232.

In this configuration, the rotation of the first motor 21 is transmitted to the wave generator 223 of the first speed reducer 22 via the first motor-side pulley 231, the first belt 233, and the first speed reducer-side pulley 232, and the wave generator 223 rotates around the second pivoting axis J2. Furthermore, the flex spline 222 rotates with a predetermined speed reduction ratio with respect to the rotation of the wave generator 223, and as a result, the second arm 122 pivots around the second pivoting axis J2 with respect to the first arm 121.

In this way, the first motor 21 is more freely disposed by adopting a configuration in which the power of the first motor 21 is transmitted to the first speed reducer 22 via the first power transmission mechanism 23. In particular, since the output shaft 211 of the first motor 21 can be disposed to be shifted from the second pivoting axis J2, overlapping between the through-hole H1 of the first speed reducer 22 and the first motor 21 can be effectively suppressed. Therefore, the shaft 36 and the wire L are easily inserted into the through-hole H1. Furthermore, for example, since diameters of the first motor-side pulley 231 and the first speed reducer-side pulley 232 are adjusted, the first power transmission mechanism 23 can be used as the speed reducer. Since the first power transmission mechanism 23 is used in combination with the first speed reducer 22, a higher speed reduction ratio can be obtained. In addition, since a configuration using the two pulleys and the belt is adopted, the pulleys and the belt can be formed of a lightweight material such as a resin material and a rubber material. Therefore, the weight of the first power transmission mechanism 23 can be reduced.

However, as the first power transmission mechanism 23, a configuration is not particularly limited. For example, the first motor-side pulley 231 and the first speed reducer-side pulley 232 may be respectively replaced with gears, and a configuration in which the first belt 233 is replaced with a chain meshing with the two gears may be adopted. In addition, the chain may be omitted, and the gears may be directly meshed with each other. However, compared to a configuration using the gears and the chain, according to a configuration using the pulley and the belt as in the present embodiment, backlash of the first power transmission mechanism 23 can be reduced, and the second arm 122 can be accurately controlled.

Next, the third drive unit 133 will be described. As illustrated in FIGS. 4 and 5, the third drive unit 133 includes a second motor 31 which is an encoder-incorporated motor, a second speed reducer 32 coupling the second arm 122 and the third arm 123, and a second power transmission mechanism 33 coupling the second motor 31 and the second speed reducer 32 and transmitting the power of the second motor 31 to the second speed reducer 32.

The second motor 31 is disposed inside the first arm 121. In addition, an output shaft 311 of the second motor 31 is disposed along the second pivoting axis J2. In addition, the output shaft 311 of the second motor 31 is disposed at a position shifted from the second pivoting axis J2. As illustrated in FIG. 3, in the present embodiment, in a plan view in the Z-axis direction, the second motor 31 is disposed at a position shifted to a positive side in the X-axis direction with respect to the second pivoting axis J2. As this second motor 31, a configuration is not particularly limited. In the present embodiment, as in the above-described first motor 21, the second motor 31 is the servo motor, particularly, the three-phase motor driven by the three-phase AC. Since the second motor 31 is the servo motor, the third arm 123 can be highly accurately and easily controlled.

As in the above-described first speed reducer 22, the second speed reducer 32 is the wave gear device. Since the wave gear device is used as the second speed reducer 32, backlash of the second speed reducer 32 can be reduced. Therefore, the third arm 123 can be accurately controlled. However, as the second speed reducer 32, a configuration is not particularly limited, and a planetary gear device, a roller cam speed reducer, or the like may be used.

As illustrated in FIG. 5, the second speed reducer 32 mainly includes a circular spline 321, a flex spline 322, and a wave generator 323. The circular spline 321 is fixed to the second arm 122, the flex spline 322 is fixed to the third arm 123, and the wave generator 323 is coupled to the second motor 31 via the second power transmission mechanism 33. In addition, the wave generator 323 has a tubular shape. Therefore, the second speed reducer 32 has a through-hole H2 communicating with the inside of the second arm 122 and the inside of the third arm 123 along the third pivoting axis J3. The wire L is inserted into the through-hole H2.

As illustrated in FIGS. 4 and 5, the second power transmission mechanism 33 includes a first transmission mechanism 34 disposed inside the first arm 121, and a second transmission mechanism 35 disposed inside the second arm 122.

The first transmission mechanism 34 includes a second motor-side pulley 341 attached to the output shaft 311 of the second motor 31, a first intermediate pulley 342 pivotally supported around the second pivoting axis J2 with respect to the first arm 121, and a second belt 343 wound around the second motor-side pulley 341 and the first intermediate pulley 342. On the other hand, the second transmission mechanism 35 includes a second speed reducer-side pulley 351 attached to the wave generator 323 which is the input shaft of the second speed reducer 32, a second intermediate pulley 352 pivotally supported around the second pivoting axis J2 with respect to the second arm 122, and a third belt 353 wound around the second speed reducer-side pulley 351 and the second intermediate pulley 352.

In addition, the second power transmission mechanism 33 includes the shaft 36 inserted into the through-hole H1 of the first speed reducer 22. The shaft 36 is disposed coaxially with the second pivoting axis J2, one end portion faces the inside of the first arm 121, and the other end portion faces the inside of the second arm 122. The first intermediate pulley 342 is fixed to one end portion of the shaft 36, and the second intermediate pulley 352 is fixed to the other end portion of the shaft 36. That is, in the second power transmission mechanism 33, the first transmission mechanism 34 and the second transmission mechanism 35 are coupled via the shaft 36. According to this configuration, the first transmission mechanism 34 disposed inside the first arm 121 and the second transmission mechanism 35 disposed inside the second arm 122 can be coupled by using a simple configuration.

In this configuration, the rotation of the second motor 31 is transmitted to the first intermediate pulley 342 via the second motor-side pulley 341 and the second belt 343, and the first intermediate pulley 342 and the second intermediate pulley 352 integrally rotate around the second pivoting axis J2. The rotation of the second intermediate pulley 352 is transmitted to the wave generator 323 of the second speed reducer 32 via the third belt 353 and the second speed reducer-side pulley 351, and the wave generator 323 rotates around the third pivoting axis J3. Furthermore, the flex spline 322 rotates with a predetermined speed reduction ratio with respect to the rotation of the wave generator 323, and as a result, the third arm 123 pivots around the third pivoting axis J3 with respect to the second arm 122.

Since this second power transmission mechanism 33 includes the first transmission mechanism 34, the second motor 31 is more freely disposed. In particular, since the output shaft 311 of the second motor 31 can be disposed to be shifted from the second pivoting axis J2, overlapping between the through-hole H1 of the first speed reducer 22 and the second motor 31 can be effectively suppressed. Therefore, the shaft 36 and the wire L are easily inserted into the through-hole H1.

Furthermore, in the second power transmission mechanism 33, the first transmission mechanism 34 can be used as the speed reducer by adjusting the diameters of the second motor-side pulley 341 and the first intermediate pulley 342. Similarly, the second transmission mechanism 35 can be used as the speed reducer by adjusting the diameters of the second speed reducer-side pulley 351 and the second intermediate pulley 352. In this way, a higher speed reduction ratio can be obtained by using the two speed reducers including the first and second transmission mechanisms 34 and 35 and the second speed reducer 32. In addition, since the first and second transmission mechanisms 34 and 35 are configured by using two pulleys and the belt, the first and second transmission mechanisms 34 and 35 can be formed of a lightweight material such as a resin material and a rubber material. Therefore, the weight of the second power transmission mechanism 33 can be reduced.

However, as the second power transmission mechanism 33, a configuration is not particularly limited. For example, with regard to the first transmission mechanism 34, the second motor-side pulley 341 and the first intermediate pulley 342 may be respectively replaced with gears, and a configuration in which the second belt 343 is replaced with a chain meshing with the two gears may be adopted. In addition, the chain may be omitted, and the gears may be directly meshed with each other. With regard to the second transmission mechanism 35, similarly, the second speed reducer-side pulley 351 and the second intermediate pulley 352 may be respectively replaced with gears, and a configuration in which the third belt 353 is replaced with a chain meshing with the two gears may be adopted. In addition, the chain may be omitted, and the gears may be directly meshed with each other. However, compared to the configuration using the gears and the chain in this way, according to the configuration using the pulleys and the belt as in the present embodiment, backlash of the second power transmission mechanism 33 can be reduced, and the third arm 123 can be accurately controlled. In addition, the first transmission mechanism 34 may be omitted, and the second motor 31 may be directly coupled to the shaft 36. In addition, in this case, the shaft 36 and the output shaft 311 may be integrally formed.

As illustrated in FIG. 3, in the present embodiment, the shaft 36 is a hollow shaft, and a through-hole 361 communicating with the inside of the first arm 121 and the inside of the second arm 122 is formed inside the shaft 36. The wire L is laid from the first arm 121 to the second arm 122 via the through-hole 361. According to this configuration, the wire L can be easily laid from the first arm 121 to the second arm 122. Furthermore, as illustrated in FIG. 5, the wire L laid to the second arm 122 is laid to the third arm 123 on the tip side through the inside of the through-hole H2 of the second speed reducer 32. According to this configuration, the wire L can be easily laid from the second arm 122 to the third arm 123.

As described above, in the vertical articulated robot 1, both the first motor 21 included in the second drive unit 132 and the second motor 31 included in the third drive unit 133 are disposed inside the first arm 121 located on a most root side of the robot arm 12. In this way, since the first and second motors 21 and 31, which are heavy objects, are disposed inside the first arm 121, the weight of the tip of the robot arm 12 can be reduced, and accordingly, the inertial moment of the robot arm 12 can be reduced. Therefore, the robot arm 12 can be accurately controlled.

In particular, in the present embodiment, only the second transmission mechanism 35 including a component related to the second transmission mechanism 35, such as a bearing member, and the wire L including a component related to the wire L, such as a tie wrap for bundling the wire L are disposed in the second arm 122. In other words, no components other than the second transmission mechanism 35 and the wire L are disposed inside the second arm 122. Therefore, the weight of the second arm 122 can be further reduced, and the inertial moment of the robot arm 12 can be further reduced. In addition, in this way, the number of components disposed in the second arm 122 is reduced. Accordingly, the second arm 122 can be shortened, and the inertial moment of the robot arm 12 can be further reduced. The drive units 134, 135, and 136 of the fourth, fifth, and sixth arms 124, 125, and 126 on the tip side may be disposed in the second arm 122 of the present embodiment. In this manner, the weight of the tip of the robot arm 12 can be reduced.

In addition, in the present embodiment, as illustrated in FIGS. 3 and 6, the first motor 21 and the second motor 31 overlap each other in the horizontal direction orthogonal to the second pivoting axis J2, that is, in a plan view in the X-axis direction. In other words, the first motor 21 and the second motor 31 are aligned in the horizontal direction. The description that “the first motor 21 and the second motor 31 overlap each other in the plan view in the horizontal direction orthogonal to the second pivoting axis J2” means that at least portions of the first motor 21 and the second motor 31 may overlap each other in a plan view in the X-axis direction. According to this configuration, the first motor 21 and the second motor 31 can be disposed closest to a lower end portion of the first arm 121, and the center of gravity of the robot arm 12 is further lowered. Therefore, the inertial moment of the robot arm 12 can be further reduced. Furthermore, in the present embodiment, the output shafts 211 and 311 of the first motor 21 and the second motor 31 are located on a lower side of the second pivoting axis J2. Therefore, the center of gravity of the robot arm 12 is further lowered, and the above-described advantageous effect becomes more remarkable.

In the present embodiment, as illustrated in FIGS. 3 and 6, the second pivoting axis J2 is located between the first motor 21 and the second motor 31 in a plan view in the vertical direction. That is, the first motor 21 is located on one side of the second pivoting axis J2 in the horizontal direction, and the second motor 31 is located on the other side. In addition, in a plan view in the vertical direction, the first pivoting axis J1 may be located between the first motor 21 and the second motor 31, that is, the first motor 21 may be located on one side in the horizontal direction with respect to the first pivoting axis J1, and the second motor 31 may be located on the other side. According to this configuration, a deviation of the center of gravity of the first arm 121 with respect to the first pivoting axis J1 can be effectively suppressed. Therefore, the first arm 121 can more smoothly and accurately pivot around the first pivoting axis J1.

In the present embodiment, the first and second motors 21 and 31 are disposed inside the first arm 121. However, without being limited thereto, at least one of the first and second motors 21 and 31 may be disposed outside the first arm 121. That is, at least one of the first and second motors 21 and 31 may be exposed outside the vertical articulated robot 1.

Hitherto, the vertical articulated robot 1 is described. As described above, the vertical articulated robot 1 includes the base 11, the first arm 121 pivoting around the first pivoting axis J1 which is the vertical axis with respect to the base 11, the second arm 122 coupled to the first arm 121 and pivoting around the second pivoting axis J2 which is the first horizontal axis with respect to the first arm 121, the third arm 123 coupled to the second arm 122 and pivoting around the third pivoting axis J3 which is the second horizontal axis with respect to the second arm 122, the first motor 21 causing the second arm 122 to pivot around the second pivoting axis J2 with respect to the first arm 121, and the second motor 31 causing the third arm 123 to pivot around the third pivoting axis J3 with respect to the second arm 122. Each of the first motor 21 and the second motor 31 is disposed in the first arm 121. In this way, according to the configuration in which the first and second motors 21 and 31, which are the heavy objects, are disposed in the first arm 121, the weight of the tip of the robot arm 12 can be reduced, and accordingly, the inertial moment of the robot arm 12 can be reduced. Therefore, the robot arm 12 can be accurately controlled.

In addition, as described above, the vertical articulated robot 1 includes the first speed reducer 22 coupling the first arm 121 and the second arm 122, and the first power transmission mechanism 23 coupling the first motor 21 and the first speed reducer 22 and transmitting the power of the first motor 21 to the first speed reducer 22. According to this configuration, the first motor 21 is more freely disposed.

In addition, as described above, the first power transmission mechanism 23 includes the first motor-side pulley 231 disposed in the output shaft 211 of the first motor 21, the first speed reducer-side pulley 232 disposed in the wave generator 223 which is the input shaft of the first speed reducer 22, and the first belt 233 wound around the first motor-side pulley 231 and the first speed reducer-side pulley 232. According to this configuration, a configuration of the first power transmission mechanism 23 is simplified. In addition, the first power transmission mechanism 23 can be used as the speed reducer by adjusting the diameters of the first motor-side pulley 231 and the first speed reducer-side pulley 232. Therefore, a higher speed reduction ratio can be obtained by using the first power transmission mechanism 23 and the first speed reducer 22. Furthermore, backlash of the first power transmission mechanism 23 can be reduced, and the second arm 122 can be accurately controlled.

In addition, as described above, the vertical articulated robot 1 includes the second speed reducer 32 coupling the second arm 122 and the third arm 123, and the second power transmission mechanism 33 coupling the second motor 31 and the second speed reducer 32 and transmitting the power of the second motor 31 to the second speed reducer 32. According to this configuration, the second motor 31 is more freely disposed.

In addition, as described above, the second power transmission mechanism 33 includes the first transmission mechanism 34 disposed inside the first arm 121 and the second transmission mechanism 35 disposed inside the second arm 122. In addition, the first transmission mechanism 34 includes the second motor-side pulley 341 disposed in the output shaft 311 of the second motor 31, the first intermediate pulley 342 rotating around the second pivoting axis J2, and the second belt 343 wound around the second motor-side pulley 341 and the first intermediate pulley 342. In addition, the second transmission mechanism 35 includes the second intermediate pulley 352 rotating around the second pivoting axis J2 together with the first intermediate pulley 342, the second speed reducer-side pulley 351 disposed at the wave generator 323 which is the input shaft of the second speed reducer 32, and the third belt 353 wound around the second intermediate pulley 352 and the second speed reducer-side pulley 351. According to this configuration, a configuration of the second power transmission mechanism 33 is simplified. In addition, the first transmission mechanism 34 can be used as a speed reducer by adjusting the diameters of the second motor-side pulley 341 and the first intermediate pulley 342, and the second transmission mechanism 35 can be used as the speed reducer by adjusting the diameters of the second speed reducer-side pulley 351 and the second intermediate pulley 352. Therefore, a higher speed reduction ratio can be obtained by using the first and second transmission mechanisms 34 and 35 and the second speed reducer 32. Furthermore, backlash of the second power transmission mechanism 33 can be reduced, and the third arm 123 can be accurately controlled.

In addition, as described above, the first speed reducer 22 is provided with the through-hole H1 communicating with the inside of the first arm 121 and the inside of the second arm 122 along the second pivoting axis J2. The first intermediate pulley 342 and the second intermediate pulley 352 are coupled via the shaft 36 inserted into the through-hole H1. According to this configuration, the first intermediate pulley 342 and the second intermediate pulley 352 can be coupled by using a simple configuration, and can be integrally rotated around the second pivoting axis J2.

In addition, as described above, the shaft 36 is the hollow shaft, and the wire L is laid between the first arm 121 and the second arm 122 via the shaft 36. According to this configuration, the wire L is easily laid.

In addition, as described above, the second arm 122 is coupled to the first arm 121 from one side in the direction along the second pivoting axis J2. That is, the second arm 122 is supported by the first arm 121 in a cantilevered manner. According to this configuration, a weight of the second arm 122 can be reduced. Therefore, the weight of the overall robot arm 12 can be reduced, and accordingly, an inertial moment of the robot arm 12 can be reduced.

In addition, as described above, the first motor 21 and the second motor 31 overlap each other in a plan view in the horizontal direction orthogonal to the second pivoting axis J2. According to this configuration, both the first motor 21 and the second motor 31 can be disposed closer to the lower end side of the first arm 121, and the center of gravity of the robot arm 12 is further lowered. Therefore, the inertial moment of the robot arm 12 can be further reduced.

In addition, as described above, the second pivoting axis J2 is located between the first motor 21 and the second motor 31 in a plan view in the vertical direction. According to this configuration, a deviation of the center of gravity of the first arm 121 with respect to the first pivoting axis J1 can be effectively suppressed. Therefore, the first arm 121 can more smoothly and accurately pivot around the first pivoting axis J1.

### Second Embodiment

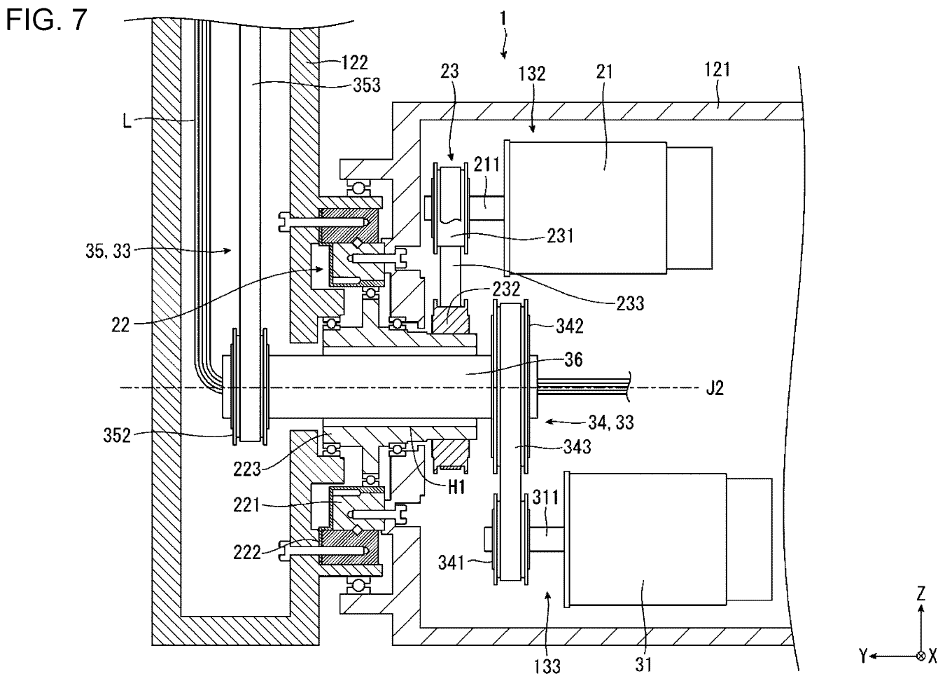

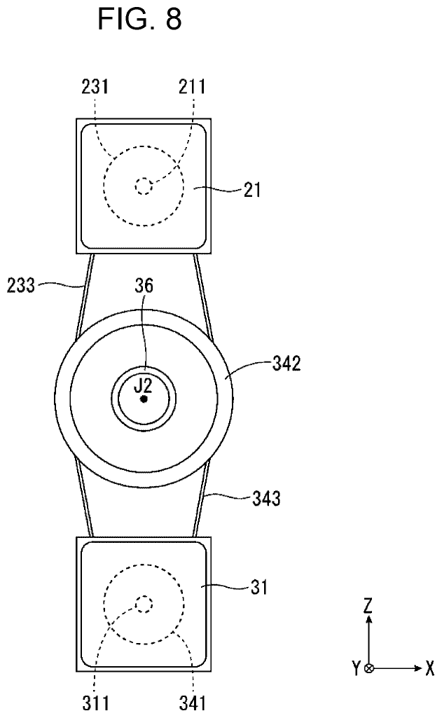

FIG. 7 is a cross-sectional view illustrating a vertical articulated robot according to a second embodiment. FIG. 8 is a side view illustrating a disposition of a first motor and a second motor.

The present embodiment is the same as the above-described first embodiment except that the disposition of the first and second motors 21 and 31 in the first arm 121 is different. In the following description, the present embodiment will be described with a focus on differences from the first embodiment described above, and the description of the same matters will not be repeated. In addition, in each of the drawings of the present embodiment, the same reference numerals are assigned to the same configurations as those of the embodiment described above.

As illustrated in FIGS. 7 and 8, in the vertical articulated robot 1 of the present embodiment, the first motor 21 and the second motor 31 overlap each other in the vertical direction, that is, in a plan view in the Z-axis direction. In other words, the first motor 21 and the second motor 31 are aligned in the vertical direction. The description that “the first motor 21 and the second motor 31 overlap each other in the plan view in the vertical direction” means that at least portions of the first motor 21 and the second motor 31 may overlap each other in a plan view in the Z-axis direction. According to this configuration, spreading of the first arm 121 in the horizontal direction can be suppressed, and the size of the first arm 121 can be reduced. Therefore, the weight of the first arm 121 can be reduced, and the inertial moment of the robot arm 12 can be further reduced.

In the present embodiment, the first motor 21 is located on the upper side of the second motor 31. However, without being limited thereto, for example, the first motor 21 may be located on the lower side of the second motor 31. In addition, in the present embodiment, the first motor 21 is located on the upper side of the second pivoting axis J2, and the second motor 31 is located on the lower side of the second pivoting axis J2. However, without being limited thereto, for example, the first motor 21 may be located on the lower side of the second pivoting axis J2, and the second motor 31 may be located on the upper side of the second pivoting axis J2. Both the first and second motors 21 and 31 may be both located on the upper side of the second pivoting axis J2, and both the first and second motors 21 and 31 may be located on the lower side of the second pivoting axis J2.

As described above, in the vertical articulated robot 1 of the present embodiment, the first motor 21 and the second motor 31 overlap each other in a plan view in the vertical direction. According to this configuration, spreading of the first arm 121 in the horizontal direction can be suppressed, and the size of the first arm 121 can be reduced. Therefore, the weight of the first arm 121 can be reduced, and the inertial moment of the robot arm 12 can be further reduced.

Even in the second embodiment configured in this way, the same advantageous effect as that of the first embodiment described above can be achieved.

### Third Embodiment

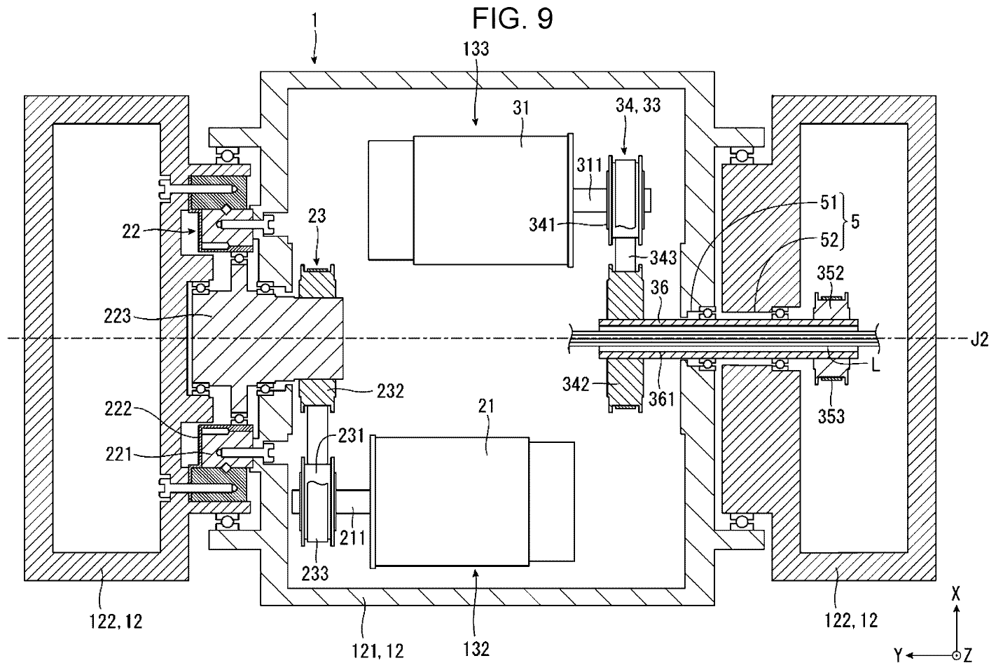

FIG. 9 is a cross-sectional view illustrating a vertical articulated robot according to a third embodiment.

The present embodiment is the same as the first embodiment described above except that the configurations of the second arm 122, the second drive unit 132, and the third drive unit 133 are different. In the following description, the present embodiment will be described with a focus on differences from the first embodiment described above, and the description of the same matters will not be repeated. In addition, in the drawing of the present embodiment, the same reference numerals are assigned to the same configurations as those of the embodiment described above.

As illustrated in FIG. 9, in the vertical articulated robot 1 of the present embodiment, the second arm 122 is coupled to the first arm 121 from both sides in the direction along the second pivoting axis J2. That is, the second arm 122 is supported on both sides by the first arm 121. According to this configuration, for example, rigidity of the second arm 122 is improved, compared to the first embodiment described above. Therefore, vibrations of the second arm 122 can be effectively suppressed.

In addition, as in the first embodiment described above, in a coupling portion on one side in the direction along the second pivoting axis J2, the first arm 121 and the second arm 122 are coupled via the first speed reducer 22. In contrast, in a coupling portion on the other side in the direction along the second pivoting axis J2, the first arm 121 and the second arm 122 are coupled via a bearing. In addition, the portion has a communication hole 5 communicating with the inside of the first arm 121 and the inside of the second arm 122 along the second pivoting axis J2. The communication hole 5 is formed in such a manner that a first communication hole 51 formed in the first arm 121 and a second communication hole 52 formed in the second arm 122 overlap each other. The shaft 36 coupling the first intermediate pulley 342 and the second intermediate pulley 352 is inserted into the communication hole 5. Furthermore, the wire L is laid from the first arm 121 to the second arm 122 through the inside of the shaft 36.

In the present embodiment configured in this way, the shaft 36 and the wire L do not need to be inserted into the first speed reducer 22. Therefore, the wave generator 223 of the first speed reducer 22 has a solid structure. In this way, since the wave generator 223 has the solid structure, the rigidity of the first speed reducer 22 can be improved, compared to the first embodiment described above. Therefore, vibrations of the second arm 122 can be effectively suppressed. In addition, compared to the first embodiment described above, the size and the weight of the first speed reducer 22 can be reduced, and accordingly, the size and the weight of the robot arm 12 can be reduced. Therefore, the inertial moment of the robot arm 12 can be reduced.

As described above, in the vertical articulated robot 1 of the present embodiment, the second arm 122 is coupled to the first arm 121 from both sides in the direction along the second pivoting axis J2. According to this configuration, the rigidity of the second arm 122 can be improved. In addition, the shaft 36 coupling the first intermediate pulley 342 and the second intermediate pulley 352 can be disposed in a coupling portion different from the first speed reducer 22. Therefore, since the wave generator 223 has the solid structure, the rigidity of the first speed reducer 22 can be improved. Therefore, vibrations of the second arm 122 can be effectively suppressed.

Even in the third embodiment as described above, the same advantageous effect as that of the first embodiment described above can be achieved.

### Fourth Embodiment

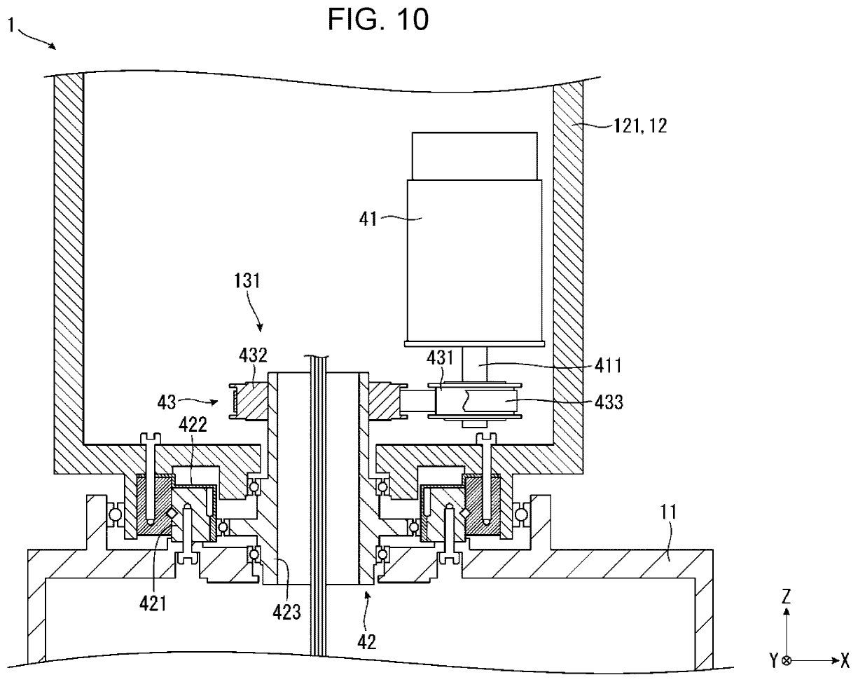

FIG. 10 is a cross-sectional view illustrating a vertical articulated robot according to a fourth embodiment.

The present embodiment is the same as the first embodiment described above except that the third motor 41 included in the first drive unit 131 is disposed inside the first arm 121. In the following description, the present embodiment will be described with a focus on differences from the first embodiment described above, and the description of the same matters will not be repeated. In addition, in the drawing of the present embodiment, the same reference numerals are assigned to the same configurations as those of the embodiment described above.

As illustrated in FIG. 10, in the vertical articulated robot 1 of the present embodiment, the third motor 41 included in the first drive unit 131 causing the first arm 121 to pivot around the first pivoting axis J1 with respect to the base 11 is disposed inside the first arm 121. Although not particularly described, in the first embodiment described above, the third motor 41 is disposed inside the base 11. In contrast, since the third motor 41 is disposed inside the first arm 121 as in the present embodiment, the size of the base 11 can be reduced. Therefore, an installation area of the vertical articulated robot 1 can be reduced.

As in the second drive unit 132, the first drive unit 131 includes the third motor 41 which is an encoder-incorporated motor, the third speed reducer 42 coupling the base 11 and the first arm 121, and a third power transmission mechanism 43 coupling the third motor 41 and the third speed reducer 42 and transmitting the power of the third motor 41 to the third speed reducer 42.

As in the first motor 21, the third motor 41 is the servo motor, in particular, the three-phase motor driven by the three-phase AC. In addition, as in the first speed reducer 22, the third speed reducer 42 is the wave gear device, and mainly includes a circular spline 421, a flex spline 422, and a wave generator 423. In addition, as in the first power transmission mechanism 23, the third power transmission mechanism 43 includes a third motor-side pulley 431 attached to an output shaft 411 of the third motor 41, a third speed reducer-side pulley 432 attached to the wave generator 423 which is the input shaft of the third speed reducer 42, and a fourth belt 433 wound around the third motor-side pulley 431 and the third speed reducer-side pulley 432.

Even in the fourth embodiment as described above, the same advantageous effect as that of the first embodiment described above can be achieved.

Hitherto, the vertical articulated robot of the present disclosure is described based on the illustrated embodiments. Meanwhile, the present disclosure is not limited thereto, and the configuration of each unit can be replaced with any configuration having the same function. In addition, any other components may be added to the present disclosure. In addition, the respective embodiments described above may be appropriately combined with each other.

1. A vertical articulated robot comprising:
a base;
a first arm pivoting around a vertical axis with respect to the base;
a second arm coupled to the first arm and pivoting around a first horizontal axis with respect to the first arm;
a third arm coupled to the second arm and pivoting around a second horizontal axis with respect to the second arm;
a first motor causing the second arm to pivot around the first horizontal axis with respect to the first arm; and
a second motor causing the third arm to pivot around the second horizontal axis with respect to the second arm, wherein
the first motor and the second motor are respectively disposed in the first arm.

2. The vertical articulated robot according to claim 1, further comprising:
a first speed reducer coupling the first arm and the second arm; and
a first power transmission mechanism coupling the first motor and the first speed reducer and transmitting power of the first motor to the first speed reducer.

3. The vertical articulated robot according to claim 2, wherein
the first power transmission mechanism includes
a first motor-side pulley disposed in an output shaft of the first motor,
a first speed reducer-side pulley disposed in an input shaft of the first speed reducer, and
a first belt wound around the first motor-side pulley and the first speed reducer-side pulley.

4. The vertical articulated robot according to claim 3, further comprising:
a second speed reducer coupling the second arm and the third arm; and
a second power transmission mechanism coupling the second motor and the second speed reducer and transmitting power of the second motor to the second speed reducer.

5. The vertical articulated robot according to claim 4, wherein
the second power transmission mechanism includes a first transmission mechanism disposed inside the first arm and a second transmission mechanism disposed inside the second arm,
the first transmission mechanism includes
a second motor-side pulley disposed in an output shaft of the second motor,
a first intermediate pulley rotating around the first horizontal axis, and
a second belt wound around the second motor-side pulley and the first intermediate pulley, and
the second transmission mechanism includes
a second intermediate pulley rotating around the first horizontal axis together with the first intermediate pulley,
a second speed reducer-side pulley disposed in an input shaft of the second speed reducer, and
a third belt wound around the second intermediate pulley and the second speed reducer-side pulley.

6. The vertical articulated robot according to claim 5, wherein
the first speed reducer is provided with a through-hole communicating with an inside of the first arm and an inside of the second arm along the first horizontal axis, and
the first intermediate pulley and the second intermediate pulley are coupled via a shaft inserted into the through-hole.

7. The vertical articulated robot according to claim 6, wherein
the shaft is a hollow shaft, and
a wire is laid between the first arm and the second arm via an inside of the shaft.

8. The vertical articulated robot according to claim 1, wherein
the second arm is coupled to the first arm from one side in a direction along the first horizontal axis.

9. The vertical articulated robot according to claim 1, wherein
the second arm is coupled to the first arm from both sides in a direction along the first horizontal axis.

10. The vertical articulated robot according to claim 1, wherein
the first motor and the second motor mutually overlap in a plan view in a horizontal direction orthogonal to the first horizontal axis.

11. The vertical articulated robot according to claim 10, wherein
in a plan view in a vertical direction, the first horizontal axis is located between the first motor and the second motor.

12. The vertical articulated robot according to claim 1, wherein
the first motor and the second motor mutually overlap in a plan view in a vertical direction.
